(19) United States
(12) Patent Application Publication
(10) Pub. No.: US 2012/0109555 A1
(43) Pub. Date: May 3, 2012

(54) ADAPTIVE RATING FOR BACKUP POWER SUPPLY

(76) Inventors: Daniel Humphrey, Houston, TX (US); Zachary J. Gerbozy, Spring, TX (US)

(21) Appl. No.: 12/916,800

(22) Filed: Nov. 1, 2010

(51) Int. Cl. G06F 19/00; G01N 27/416

(52) U.S. Cl. 702/63; 324/426

(57) ABSTRACT

Systems and methods of an adaptive rating for a backup power supply are disclosed. An exemplary method includes measuring electrical output for a load. The method also includes determining an adaptive rating for at least one battery module of a backup power supply. The method also includes storing changing adaptive ratings for the at least one battery module over time based on the measured electrical output for the load.

### BACKGROUND

Backup power supply or Uninterruptible Power Supply (UPS) devices are commonly available for computer systems and other electronic devices where uninterrupted power is desired (e.g., to continue providing power during a power outage). The UPS device replaces or supplements electrical power from the utility company with electrical power from a battery (or batteries) in the UPS device. The battery is able to continue providing power, at least for a limited time, until electrical power from the utility provider can be restored. Once electrical power from the utility company is restored, the electrical power from the utility company is used to recharge the battery in the UPS device so that the battery is fully charged the next time there is a power outage.

UPS devices are commonly utilized for large datacenters, where out of abundant precaution, the UPS devices are typically oversized for the actual power requirements of the datacenter to limit or altogether avoid system down time. Likewise out of abundant precaution, UPS devices are typically rated higher than they need to be so that the UPS devices are replaced early on to avoid failures during a power outage. However, such ratings result in premature declarations that the batteries are “bad.” This in turn imposes unnecessary operating expenses and/or warranty claims. That is, the batteries and/or entire UPS device is disposed of even though the UPS device may still be able to provide acceptable service.

### BRIEF DESCRIPTION OF THE DRAWINGS

FIG. 1 is a plan view of an example backup power supply system as it may be implemented in a rack environment.

FIG. 2 is a block diagram showing components of the example backup power supply system as it may be used to power a load.

FIG. 3 is a flowchart showing example operations which may be implemented for adaptive rating of backup power supply systems.

FIGS. 4a-b show examples of determining and using an adaptive rating for a backup power supply system.

### DETAILED DESCRIPTION

Backup power supply systems and methods for determining and using an adaptive rating are disclosed. An example system may include a battery module (including one or more batteries) for providing electrical power to a load during a power outage. A power monitor is coupled between the battery module and the load. The power monitor measures electrical output by the battery module for the load. A processing module is configured to receive input from the power monitor and calculate a rating for the battery module based on the measured electrical output. A register is configured to receive output from the processor. The register is dynamically updated with the rating for the backup power supply.

Accordingly, the backup power supply system can be rated based on actual use. For example, the rating may be adapted to the specific electronic devices that need to be powered during an outage, and other operating conditions such as temperature, battery age, etc. Use of an adaptive rating reduces or altogether eliminates premature “end-of-life” determinations for the batteries, and therefore reduces unnecessary operating expenses and/or warranty claims. The backup power supply system (or at least the batteries) that are still in good operating condition can continue to be used for the entire life of the product.

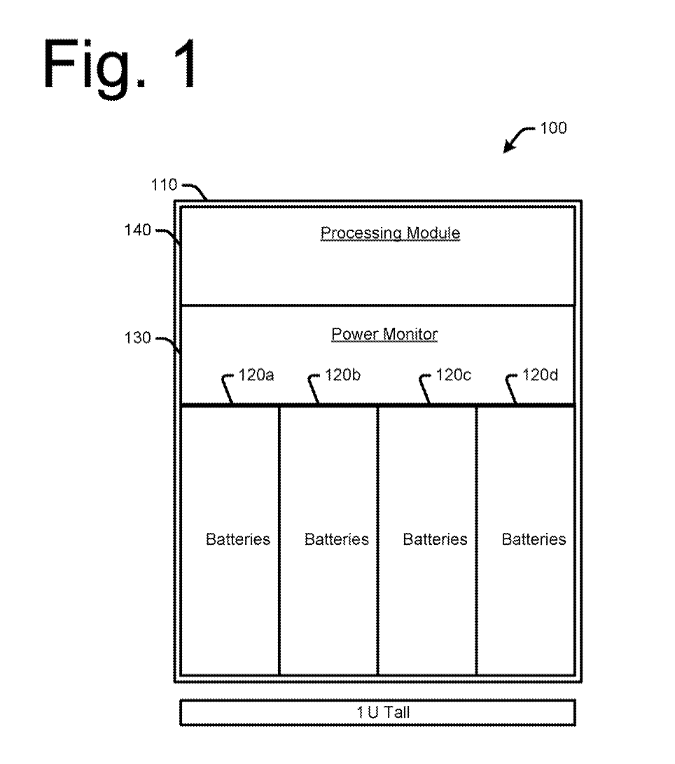

FIG. 1 is a plan view of an example backup power supply system 100 as it may be implemented in a rack environment. The backup power supply system 100 may also be referred to herein as an Uninterruptible Power Supply (UPS) device, although the backup power supply system 100, even when referred to as a UPS device, is different than traditional UPS devices for reasons which will become apparent from the following description of various example embodiments.

The backup power supply system 100 may include a housing 110. In an example, the housing 110 is sized to fit within a rack environment. Accordingly, the backup power system 100 may be used to power one or more devices within a single IT enclosure, a rack of IT enclosures, or racks of IT enclosures. In the example shown in FIG. 1, the housing 110 is sized to be 1 U tall. However, other sizes for the housing 110 are also contemplated and the backup power supply system 100 is not limited to any particular size. Sizing may depend on a wide variety of design considerations, such as the size battery modules being used, the desired backup power, and/or the overall size of the backup power supply system, to name only a few examples of design considerations.

The housing 110 includes an auxiliary power source, such as one or more battery modules 120a-d each including one or more batteries (or battery cells). Although four battery modules 120a-d are shown in FIG. 1, it is noted that any number of battery modules may be provided.

The housing 110 may also include a power monitor 130. In an embodiment, one power monitor 130 is provided for all of the battery modules 120a-d. In other embodiments, multiple power monitors (not shown) may also be provided. For example, each power monitor may correspond to an individual battery module. In other examples, there need not be a 1:1 correlation between power monitors and battery modules. That is, a single power monitor may be provided for two or more battery modules (e.g., battery modules of the same type).

In any event, the power monitor 130 is coupled to the battery modules 120a-d in any suitable manner so as to measure power provided to a load (e.g., electronic devices in the rack environment). The power monitor 130 is used to measure at least one electrical characteristic (e.g., voltage, current, inductance) provided by the backup power system 100 during use or in “real-time.”

The power monitor 130 may also be communicatively coupled to a processing module 140. The processing module 140 receives input from the power monitor 130 and determines a rating for the backup power system 100 based on the measured electrical characteristic, as will be described in more detail below. For now it is sufficient to understand that the processing module 140 may include a processor (or processing units) and a computer readable storage configured to store program code (e.g., firmware) and parameters for determining the rating. The program code is executable by the processor to determine the rating for the backup power supply system 100. The processing module 140 may also include data structure (e.g., one or more register) for storing and dynamically and adaptively updating the rating for the backup power supply system based on the measured electrical characteristic.

Before continuing, it is noted that the backup power supply system 100 may be used with any of a wide variety of computing systems or other electronic devices, and is not limited to use in a rack environment. For example, the backup power supply system may also be utilized with stand-alone personal desktop or laptop computers (PC), workstations, consumer electronic (CE) devices, or appliances, to name only a few examples.

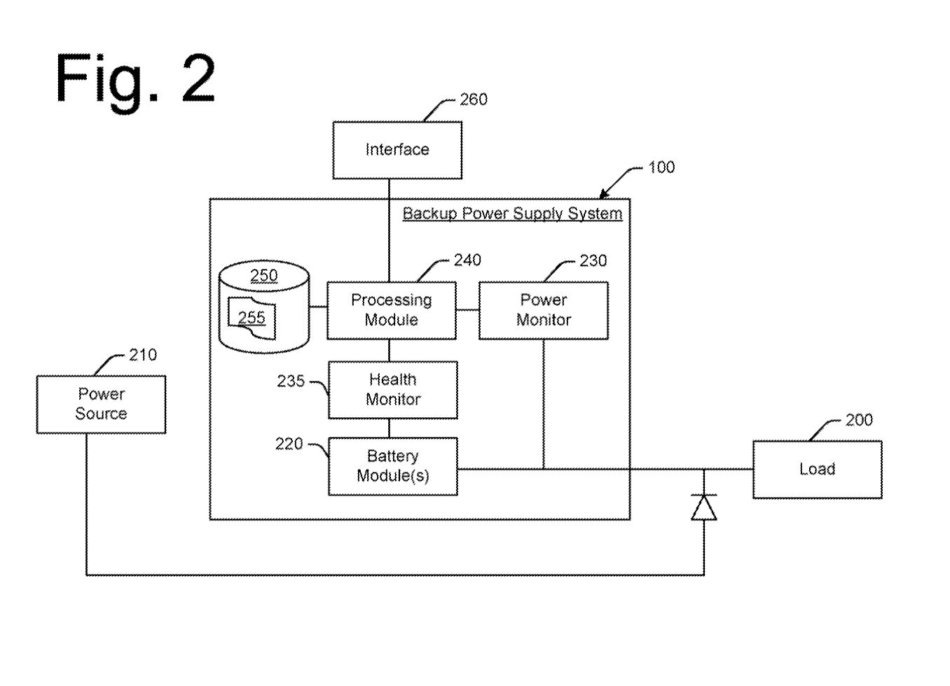

FIG. 2 is a block diagram showing components of the example backup power supply system 100 as it may be used to power a load 200. A power source 210 (e.g., a power outlet) may also be connected to the load 200. In the embodiment shown in FIG. 2, the power source is connected through the backup power supply system 100. However, other connections may also be made between the power source 210, the backup power supply system 100, and the load 200. In general, electrical power to the load 200 is provided primarily by the power source 210, but in the event that electrical power cannot be reliably provided by the power source 210, then the backup power supply system 100 provides electrical power to at least a portion of the load 200.

During operation, current flows in two directions. In a charge mode (or online mode), the backup power supply system 100 receives electrical power from the power source 210 to charge the battery modules 220. Accordingly, electrical power is provided from the power source 210 to one or more electronic devices (i.e., the load 200), by operating in a “pass-through” mode.

If the power source 210 is disrupted (e.g., during a power failure), or degraded, the backup power supply system 100 may come online so that one or more battery modules 220 provide electrical power to at least a portion of the load 200. When current flows from the battery module 220, the backup power supply system 100 is in a discharge mode and is being used to power the load (e.g., during a power outage). During discharge mode, the battery module 220 provides electrical power to the load 200.

The backup power supply system 100 may also include communications, monitoring, and processing circuitry and program code configured to monitor electrical power provided to the load 200 and dynamically and adaptively determine a rating for the backup power supply system 100.

In the embodiment shown in FIG. 2, the backup power supply system 100 includes a power monitor 230, a battery health monitor 235, and a processing module 240. Power monitor 230 may be any suitable circuitry configured to measure an electrical characteristic of the electrical power being provided to the load 200. In one example, power monitor 230 measures at least voltage and current which may be used by the processing module 240 to determine apparent power. Battery health monitor 235 monitors the ability of the battery module 220 to provide electrical power to the load.

The power monitor 230 and the battery health monitor 235 are communicatively coupled to the processing module 240 to provide information determined or measured by the power monitor 230 and the battery health monitor 235, to the processing module 240.

Processing module 240 may include one or more processor (or processing units). Processing module 240 is also operatively associated with one or more computer readable storage 250, which may store program code and at least one register 255. During operation, the program code (e.g., firmware and/or software) may be accessed and executed by the processor to implement one or more of the capabilities provided by the backup power supply system 100.

In an embodiment, processing module 240 receives information about the electrical power provided to the load 200 from the power monitor 230. The processing module 240 uses this information to determine a rating for the backup power supply system 100. The rating may be determined as follows.

Electrical power is the rate of flow of energy in a circuit, and is expressed mathematically as current times voltage (P=IV). In an alternating current (AC) circuit, both current and voltage are represented by sinusoidal waveforms. The AC circuit includes a reactant component (inductance and capacitance) and a resistant component (resistance), and hence, the current and the voltage waveforms are typically not in phase with one other. When impedance is a pure resistance, apparent power is the same as real power. But the reactant component causes the apparent power to be greater than the real power. In an AC circuit, real power is measured in Watts (W) and is typically less than apparent power measured in Volt-Amps (VA).

In a UPS, the rating used for battery health determinations is typically in terms of real power (expressed in W). For example, the rating for a UPS may be 600 W. When the battery is tested, if the battery is not able to produce the output equal to the rating (e.g., actual output is only 500 W), then the battery is determined to be bad. A so-called “bad battery” may be replaced under warranty or disposed of if it no longer meets the power rating.

However, the systems and methods disclosed herein use a different rating, such as apparent power (expressed in VA), or other rating, but in either case, the rating is based on actual conditions. In an embodiment, a maximum power that is needed during an outage is determined (e.g., by the power monitor 230 and the processing module 240). This maximum power is then set as the rating for the backup power supply system 100. For example, the maximum apparent power as measured may be 500 W. Accordingly, the rating is set at 500 W. Then when the battery is tested (e.g., by the health monitor 235 and the processing module 240), and again assuming from the example above that the battery was only able to output 500 W, then the battery still satisfies the rating and is not determined to be bad. The battery can continue to be used, does not need to be disposed, and is not subject to a warranty replacement.

In another embodiment, the rating may be determined based on average power for a predetermined time. For example, the rating may be determined for a predetermined time, such as, 5 minutes, 10 minutes, or 1 hour. Or for example, the rating may be based on an expected “ride-through” time for the backup power supply system 100. The ride-through time of course is dependent on a number of factors, such as but not limited to, the number/size/type of battery modules, the number/type/usage of equipment (the load), whether the backup power supply system has had sufficient time to recharge, and age of the backup power supply system, to name only a few examples.

The rating may be updated on any suitable basis. In one example, the rating may be updated at regular intervals (e.g., 1× per week, 1× per year, seasonally). In another example, the rating may be updated whenever the user decides to update the rating (e.g., by pressing a button on the backup power supply). For purposes of illustration, the user may want to update the rating when equipment is installed or replaced; when the backup power supply is moved to another physical location; or when the backup power supply is repaired (e.g., a new battery module is installed).

In another example, the rating may be updated on an ongoing basis, such as whenever the power measurements are outside a threshold value. For purposes of illustration, the rating may be set to 500 W with a 50 W threshold. If the present power measurements are between 450 W and 550 W, the rating remains 500 W. But if the present power measurements are below 450 W (e.g., 425 W) or above 550 W (e.g., 600 W), then the rating is changed (e.g., to 425 W or 550 W in the above examples). Accordingly, the backup power supply system 100 has a rating that is both dynamic (updated over time) and adaptive (changing based on actual operating conditions).

The threshold may also be adjustable. For example, the threshold may be adjustable by the user by increasing the threshold to reduce service calls, or by decreasing the threshold to enhance reliability. Or for example, the manufacturer or installer may adjust the threshold based on the current operating conditions, or based on desired (or purchased) service level or warranty.

The backup power supply system 100 may also include an interface 260 operatively associated with the processing module 240. Interface module 260 may be configured to display or otherwise generate output for a user (and may also receive input from a user). This output may be related to the rating and/or battery health. For purposes of illustration, an interface may be provided which includes light-emitting diode (LED) status indicators. The status indicators may be actuated to indicate whether power is being supplied by the power source 210 or by the battery module 220 (or a combination thereof), and to indicate performance, problems, etc. For example, the status indicators may be actuated to indicate whether the rating should be or has been changed, whether the battery health is “bad” based on a comparison of actual output and the rated output, and so forth.

In an embodiment, there are at least two general status outputs for the backup power supply system 100. The first is rating update indicator. This signal indicates to a user that the rating has been or should be updated based on a change in operating conditions (e.g., operating temperature or load 200). In response, the user may press a button to reset the rating. The second is a battery health indicator. This signal indicates to a user that the battery module 220 can no longer support the load 200 based on the rating.

Of course the user interface 260 is not limited to LED status indicators or to any particular indications. The user interface may be internal or external to the backup power supply system 100. The user interface may be any suitable type and used for any of a wide variety of input/output (I/O). For example, the user interface 260 may be via a computer or web-enabled interface. Other examples of I/O include, but are not limited to, a reset function, a test feature, power on/off, etc. This input/output may be relayed between the components of the backup power supply system 100 and the user via interface 260 by signal wiring or wireless communications.

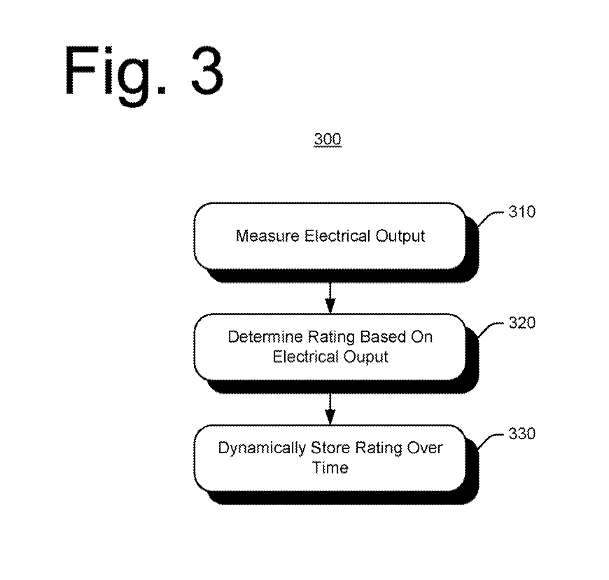

FIG. 3 is a flowchart showing operations 300 which may be implemented for adaptive rating of backup power supplies. Operations 300 may be embodied as logic instructions (e.g., firmware) on one or more computer-readable medium in the remote unit of the UPS device. When executed on a processor in the remote unit of the UPS device, the logic instructions cause a general purpose computing device to be programmed as a special-purpose machine that implements the described operations. The operations may also be implemented in hardware (e.g., device logic), or a combination of hardware and firmware. In an exemplary implementation, the components and connections depicted in the figures may be used for the described operations.

In operation 310, electrical output is measured to a load. In operation 320, a rating is determined based on the electrical output. In operation 330, the rating is dynamically stored over time for the backup power supply based on actual usage. Accordingly, the rating can be customized, is updated dynamically or in “real-time,” and is adaptive to different conditions (e.g., operating conditions, environmental conditions, and load configuration).

The operations shown and described herein are provided to illustrate exemplary implementations of adaptive ratings for backup power supply systems. It is noted that the operations are not limited to the ordering shown. For example, operations may be ordered one before the other or performed simultaneously with one another.

Still other operations not shown may also be implemented. For example, operations may also include determining the rating based on apparent power. Operations may also include updating the rating every time apparent power increases and decreases outside a threshold value.

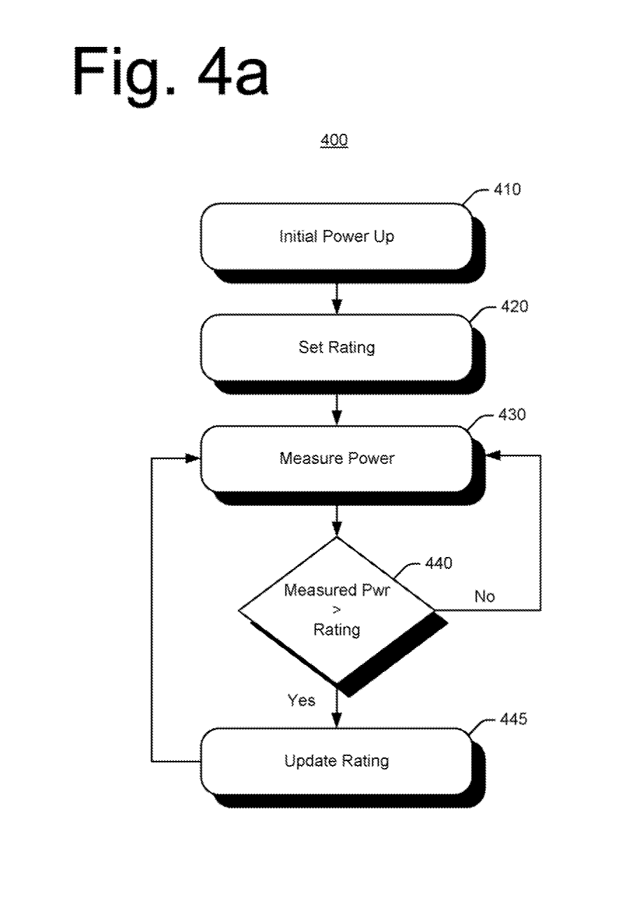

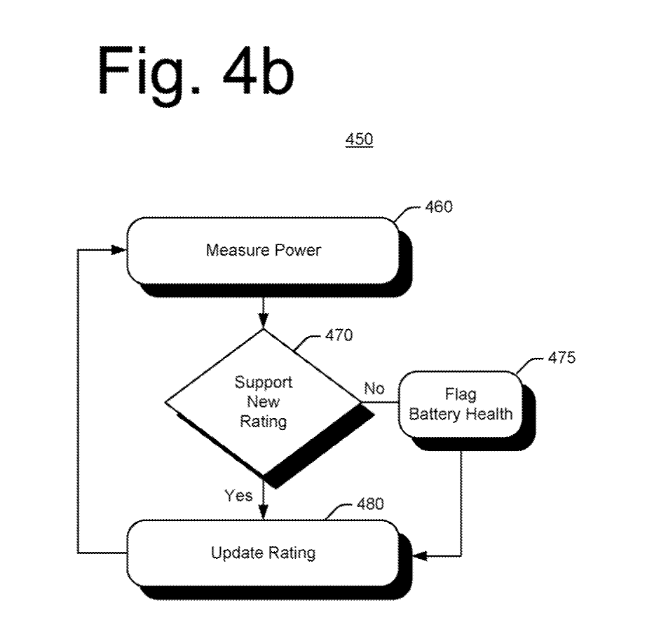

FIG. 4a shows an example 400 of generating an adaptive rating for a backup power supply system. In this example, the backup power supply system is powered-up at 410. At 420, the rating for the backup power supply is set to an initial value (e.g., 0 VA, or 500 VA). At 430, the power monitor measures electrical output, and may further determine apparent power. At 440, a determination is made whether the measured electrical output exceeds the present rating (e.g., 500 VA). If not, then the operations loop back to 430 and the power, monitor continues measuring electrical output. If the measured electrical output (e.g., 600 VA) exceeds the maximum value, then at 445 a new rating is stored based on the measured electrical output (e.g., 600 VA), and power measurements continue at 430.

FIG. 4b shows an example 450 of a battery health interrupt based on an adaptive rating of a backup power supply. In this example, the power monitor measures electrical output at 460, and the measured electrical output (e.g., 600 VA) is compared at 470 to the ability of the backup power supply system to support this value. If the backup power supply system cannot support this output (e.g., only 500 VA is supported), then at 475, the backup power supply system (or a battery module within the backup power supply system) is flagged as failed or failing. If the backup power supply system can support this output, then at 480 a new rating (e.g., 600 VA) is stored based on the measured electrical output.

It is noted that the flowcharts shown in FIGS. 4a-b are merely provided as examples to illustrate functionality of the backup power supply system and are not intended to be limiting. Other functionality may also be implemented with other operations, not shown, using the program code described herein to provide a wide range of different functions and operability.

The exemplary embodiments shown and described are provided for purposes of illustration and are not intended to be limiting. Still other embodiments of backup power supply systems and methods are also contemplated.

1. A method comprising:
measuring electrical output for a load;
determining an adaptive rating for at least one battery module of a backup power supply; and
storing changing adaptive ratings for the at least one battery module over time based on the measured electrical output for the load.

2. The method of claim 1, further comprising determining the adaptive rating based on apparent power.

3. The method of claim 1, further comprising updating the adaptive rating every time apparent power increases and decreases outside of a threshold value.

4. The method of claim 1, further comprising alerting a user when the backup power supply system no longer satisfies the adaptive rating.

5. The method of claim 1, further comprising updating an initial factory rating with the adaptive rating based on actual operating conditions.

6. The method of claim 1, further comprising checking battery health against a current rating for the backup power supply system after each charge event and after each discharge event.

7. A backup power supply system with adaptive rating, comprising:
a battery module for providing electrical power to a load;
a power monitor coupled to the load, the power monitor configured to measure electrical output to the load; and
a storage location operatively associated with the power monitor, the storage location configured to dynamically store a rating for the backup power supply system based on the measured electrical output to the load.

8. The backup power supply system of claim 7, further comprising a processing module communicatively coupled to the power monitor and the register, the processing module determining the rating.

9. The backup power supply system of claim 7, wherein the rating for the backup power supply is maximum apparent power.

10. The backup power supply system of claim 7, wherein the rating is updated when the apparent power increases over a threshold value.

11. The backup power supply system of claim 7, wherein the rating is updated when the apparent power decreases below a threshold value.

12. The backup power supply system of claim 7, further comprising a battery health monitor configured to alert a user when the backup power supply system no longer satisfies the rating.

13. The backup power supply system of claim 7, wherein the rating is factory set to zero, and adaptive to actual operating conditions.

14. The backup power supply system of claim 7, wherein the rating is adaptive over time to changing loads.

15. The backup power supply system of claim 7, wherein the rating is customized at startup for expected operating conditions.

16. The backup power supply system of claim 7, wherein the rating is customized for properties of the battery module.

17. The backup power supply system of claim 7, wherein the rating is resettable by a user.

18. The backup power supply system of claim 7, wherein battery health is compared to the rating after a discharge event.

19. A backup power supply system with adaptive rating, comprising:
at least one battery module for providing electrical power to a load;
a power monitor coupled to the load, the power monitor configured to measure electrical output to the load;
a processing module configured to receive input from the power monitor and calculate a rating for the at least one battery module based on the measured electrical output; and
a storage location configured to dynamically store updated ratings over time for the backup power supply.

20. The backup power supply system of claim 19, wherein the rating is less than a real power rating.
